(19) United States
(12) Patent Application Publication
(10) Pub. No.: US 2002/0008024 A1
(43) Pub. Date: Jan. 24, 2002

(54) Multilayered gas sensing element employable in an exhaust system of an internal combustion engine and manufacturing method thereof

(76) Inventor: Tomio Sugiyama, Nagoya (JP)

Correspondence Address: NIXON & VANDERHYE P.C., 8th Floor, 1100 North Glebe Rd, Arlington, VA, 22201-4714, US

(21) Appl. No.: 09/873,287

(22) Filed: Jun. 5, 2001

(30) Foreign Application Priority Data
Jun. 19, 2000 (JP) 2000-183536

(51) Int. Cl. G01N 27/407

(52) U.S. Cl. 204/426; 204/424

(57) ABSTRACT

A bonding boundary intervenes between a zirconia-series solid electrolytic sheet and an alumina-series insulating sheet. The bonding boundary includes at least partly a crystal phase containing SiO2.

### BACKGROUND OF THE INVENTION

The present invention relates to a multilayered gas sensing element which is utilized in an air-fuel ratio control of an internal combustion engine for an automotive vehicle.

The gas sensing elements, incorporated in air-fuel sensors, are required to be quickly warmed up to shorten the activation time and be compact so that the air-fuel sensors can be installed in various portions.

To this end, the multilayered gas sensing elements have been recently used. According to such multilayered gas sensing elements, a gas concentration sensing portion and a heater are integrally formed.

This kinds of multilayered gas sensing elements are manufactured by laminating an alumina-series insulating sheet on which an electric heat generating element is attached, an alumina-series insulating sheet having a reference gas chamber defined therein, and a zirconia-series solid electrolytic sheet having oxygen ion conductivity which are sintered as an integrated body (refer to unexamined Japanese patent publication No. 61-172054 or unexamined Japanese patent publication No. 8-114571).

However, due to difference in properties between two sheets to be boded, the conventional multilayered gas sensing elements are generally insufficient in the strength of bonding boundary between the zirconia-series solid electrolytic sheet and the alumina-series insulating sheet. Durability and reliability of the conventional multilayered gas sensing elements are not satisfactory.

According to the multilayered gas sensing element disclosed in the unexamined Japanese patent publication No. 61-172054, a stress relaxing layer is provided. This stress relaxing layer contains alumina with additive of 25-50 wt % zirconia, so that an alumina-series layer and a zirconia-series layer can be diffusion bonded via this stress relaxing layer during sintering operation.

However, when electric power is supplied to a heat generating element embedded in this gas sensing element, the temperature of the gas sensing element increases to a higher level. The stress relaxing layer may become black partly due to reduced zirconia contained in this layer. The gas sensing element becomes frangible and will possibly cause cracks.

According to the multilayered gas sensing element disclosed in the unexamined Japanese patent publication No. 8-114571, no stress relaxing layer is provided. An alumina-series layer and a zirconia-series layer are directly bonded by diffusion bonding. This bonding is not perfect. Durability of bonding boundary is insufficient.

### SUMMARY OF THE INVENTION

To solve the above-described problems, an object of the present invention is to provide a multilayered gas sensing element which assures sufficient bonding strength at the bonding boundary between a zirconia-series solid electrolytic sheet and an alumina-series insulating sheet. Furthermore, another object of the present invention is to provide a related method for manufacturing this kind of multilayered gas sensing element.

In order to accomplish the above and other related objects, the present invention provides a multilayered gas sensing element comprising laminated layers comprising a zirconia-series solid electrolytic sheet and an alumina-series insulating sheet, a bonding boundary intervening between the zirconia-series solid electrolytic sheet and the alumina-series insulating sheet, and the bonding boundary includes at least partly a crystal phase containing silicon dioxide (SiO2).

The multilayered gas sensing element of the present invention is characterized in that the crystal phase containing SiO2 is included at least partly in the bonding boundary between the zirconia-series solid electrolytic sheet and the alumina-series insulating sheet.

Preferably, when the crystal phase is 100 wt %, the amount of SiO2 is equal to or larger than 10 wt %.

The multilayered gas sensing element of this invention functions in the following manner.

The crystal phase containing SiO2 intervenes between the zirconia-series solid electrolytic sheet and the alumina-series insulating sheet. The crystal phase causes self-reaction or interacts with other components during the sintering operation of the multilayered gas sensing element. The crystal phase is liquefied. Thus, the material transfer occurs between the zirconia-series solid electrolytic sheet and the alumina-series insulating sheet via the liquefied phase during the sintering operation.

Accordingly, the present invention provides the multilayered gas sensing element which is capable of assuring satisfactory bonding between the zirconia-series solid electrolytic sheet and the alumina-series insulating sheet.

Furthermore, while SiO2 contributes the bonding strength of the crystal phase, the crystal phase containing SiO2 does not worsen the oxygen ion conductivity of the zirconia-series solid electrolytic sheet. No blacking or migration is caused even when the crystal phase is subjected to heat generated from the heater embedded in the multilayered gas sensing element. Accordingly, the multilayered gas sensing element functions properly.

Thus, the present invention provides a multilayered gas sensing element having excellent bonding boundary between the zirconia-series solid electrolytic sheet and the alumina-series insulating sheet.

The multilayered gas sensing element of the present invention can be employed in various types of gas concentration sensors, such as an oxygen sensor, an air-fuel ratio sensor, a NOx sensor, a HC sensor, a CO sensor.

According to the multilayered gas sensing element of the present invention, it is preferable that the crystal phase containing SiO2 further contains at least one component selected from the group consisting of calcium oxide (CaO), magnesium oxide (MgO), barium oxide (BaO), and strontium oxide (SrO).

The component selected from the group consisting of CaO, MgO, BaO, and SrO interacts with SiO2 so as to promote the liquefaction of the crystal phase during the sintering operation. The material transfer in the bonding boundary advances so smoothly that reliable bonding can be assured between the zirconia-series solid electrolytic sheet and the alumina-series insulating sheet.

According to the multilayered gas sensing element of the present invention, it is preferable that bonding boundary between the zirconia-series solid electrolytic sheet and the alumina-series insulating sheet is undulated.

This arrangement provides anchor effect which ensures reliable bonding between the zirconia-series solid electrolytic sheet and the alumina-series insulating sheet.

According to the multilayered gas sensing element of the present invention, it is preferable that a crystal lattice of the zirconia-series solid electrolytic sheet is connected to a crystal lattice of the alumina-series insulating sheet in the bonding boundary.

This arrangement strengthens the bonding force between the zirconia-series solid electrolytic sheet and the alumina-series insulating sheet.

According to the multilayered gas sensing element of the present invention, it is preferable that a thermal expansion coefficient difference between the zirconia-series solid electrolytic sheet and the alumina-series insulating sheet is equal to or less than 2×10⁻⁶.

This is effective to reduce the stress acting between the zirconia-series solid electrolytic sheet and the alumina-series insulating sheet due to thermal expansion difference, thereby realizing a thermally durable bonding structure. Needless to say, it is most preferable that there is no difference in thermal expansion coefficient between the zirconia-series solid electrolytic sheet and the alumina-series insulating sheet.

According to the multilayered gas sensing element of the present invention, it is preferable that a sintering contraction coefficient difference between the zirconia-series solid electrolytic sheet and the alumina-series insulating sheet is equal to or less than 3%.

With this arrangement, it becomes possible to prevent the multilayered gas sensing element from being damaged during the sintering operation. Needless to say, it is most preferable that there is no difference in sintering contraction coefficient between the zirconia-series solid electrolytic sheet and the alumina-series insulating sheet.

Furthermore, the present invention provides a first method for manufacturing a multilayered gas sensing element comprising the steps of preparing a zirconia-series green sheet containing SiO2 and aluminum oxide (A1203) for forming a solid electrolytic sheet, preparing an alumina-series green sheet for forming an insulating sheet, bonding the zirconia-series green sheet and the alumina-series green sheet to constitute an unburnt laminated body, and sintering the unburnt laminated body.

According to the first manufacturing method of the present invention, the liquefied phase appears during the sintering operation at a region where a zirconia grain and an alumina grain contact with each other. The liquefied phase chiefly contains SiO2 which has melted into this liquefied phase from the zirconia-series green sheet during the sintering operation of the laminated green sheets.

This is effective to promote the material transfer in the bonding boundary during the sintering operation. The components constituting the liquefied phase can function as binder as they harden themselves in a cooling process succeeding the sintering operation. Thus, the first manufacturing method of the present invention makes it possible to provide reliable and excellent bonding structure for the multilayered gas sensing element.

An A1203 grain contained in the zirconia-series green sheet is well bonded to the alumina(i.e., A1203)-series green sheet. The bonding boundary between the zirconia-series solid electrolytic sheet and the alumina-series insulating sheet is undulated adequately. The undulated bonding boundary possesses the anchor effect which ensures reliable bonding between the zirconia-series solid electrolytic sheet and the alumina-series insulating sheet.

Thus, the multilayered gas sensing element manufactured according to the first manufacturing method has excellent bonding boundary between the zirconia-series solid electrolytic sheet and the alumina-series insulating sheet.

According to the first manufacturing method of the present invention, it is preferable that the zirconia-series green sheet contains SiO2 by 0.05 to 4 in weight part and A1203 by 0.5 to 4 in weight part when zirconia material is 100 in weight part, with a sum of SiO2 and A1203 being not larger than 4 in weight part.

With this composition, it becomes possible to further enhance the bonding strength and improve the bondability.

If SiO2 contained in the zirconia-series green sheet is less than 0.05 in weight part, the bondability will be worsened. If SiO2 exceeds 4 in weight part, the oxygen ion conductivity of the zirconia-series solid electrolytic sheet will be worsened.

Furthermore, if A1203 contained in the zirconia-series green sheet is less than 0.5 in weight part, the bondability will be worsened. If A1203 exceeds 4 in weight part, the oxygen ion conductivity of the zirconia-series solid electrolytic sheet will be worsened.

Furthermore, if the sum of SiO2 and A1203 exceeds 4 in weight part, the oxygen ion conductivity of the zirconia-series solid electrolytic sheet will be worsened.

Furthermore, the present invention provides a second method for manufacturing a multilayered gas sensing element, comprising the steps of preparing a zirconia-series green sheet for forming a solid electrolytic sheet, preparing an alumina-series green sheet containing SiO2 for forming an insulating sheet, bonding the zirconia-series green sheet and the alumina-series green sheet to constitute an unburnt laminated body, and sintering the unburnt laminated body.

According to the second manufacturing method of the present invention, the liquefied phase appears during the sintering operation at a region where a zirconia grain and an alumina grain contact with each other. The liquefied phase chiefly contains SiO2 which has melted into this liquefied phase from the alumina-series green sheet during the sintering operation of the laminated green sheets.

This is effective to promote the material transfer in the bonding boundary during the sintering operation. The components constituting the liquefied phase can function as binder as they harden themselves in a cooling process succeeding the sintering operation. Thus, the second manufacturing method of the present invention makes it possible to provide reliable and excellent bonding structure for the multilayered gas sensing element.

Thus, the multilayered gas sensing element manufactured according to the second manufacturing method has excellent bonding boundary between the zirconia-series solid electrolytic sheet and the alumina-series insulating sheet.

According to the second manufacturing method of the present invention, it is preferable that the alumina-series green sheet contains SiO2 by 0.05 to 10 in weight part when alumina material is 100 in weight part.

With this composition, it becomes possible to further enhance the bonding strength and improve the bondability.

If SiO2 contained in the alumina-series green sheet is less than 0.05 in weight part, the bondability will be worsened. If SiO2 exceeds 10 in weight part, the strength of sintered materials will be worsened. As a result, the strength of the gas sensing element is reduced. The gas sensing element may cause cracks.

Furthermore, the present invention provides a third method for manufacturing a multilayered gas sensing element, comprising the steps of preparing a zirconia-series green sheet containing SiO2 and A1203 for forming a solid electrolytic sheet, preparing an alumina-series green sheet containing SiO2 for forming an insulating sheet, bonding the zirconia-series green sheet and the alumina-series green sheet to constitute an unburnt laminated body, and sintering the unburnt laminated body.

According to the third manufacturing method of the present invention, the liquefied phase appears during the sintering operation at a region where a zirconia grain and an alumina grain contact with each other. The liquefied phase chiefly contains SiO2 which has melted into this liquefied phase from both the zirconia-series green sheet and the alumina-series green sheet during the sintering operation of the laminated green sheets.

This is effective to promote the material transfer in the bonding boundary during the sintering operation. The components constituting the liquefied phase can function as binder as they harden themselves in a cooling process succeeding the sintering operation. Thus, the third manufacturing method of the present invention makes it possible to provide reliable and excellent bonding structure for the multilayered gas sensing element.

Thus, the multilayered gas sensing element manufactured according to the third manufacturing method has excellent bonding boundary between the zirconia-series solid electrolytic sheet and the alumina-series insulating sheet.

According to the third manufacturing method of the present invention, it is preferable that the zirconia-series green sheet contains SiO2 by 0.05 to 4 in weight part and A1203 by 0.5 to 4 in weight part when zirconia material is 100 in weight part, with a sum of SiO2 and A1203 being not larger than 4 in weight part.

Furthermore, it is preferable that the alumina-series green sheet contains SiO2 by 0.05 to 10 in weight part when alumina material is 100 in weight part.

With this composition, it becomes possible to further enhance the bonding strength and improve the bondability.

If SiO2 contained in the zirconia-series green sheet is less than 0.05 in weight part, the bondability will be worsened. If SiO2 exceeds 4 in weight part, the oxygen ion conductivity of the zirconia-series solid electrolytic sheet will be worsened.

Furthermore, if A1203 contained in the zirconia-series green sheet is less than 0.5 in weight part, the bondability will be worsened. If A1203 exceeds 4 in weight part, the oxygen ion conductivity of the zirconia-series solid electrolytic sheet will be worsened. Furthermore, if the sum of SiO2 and A1203 exceeds 4 in weight part, the oxygen ion conductivity of the zirconia-series solid electrolytic sheet will be worsened.

If SiO2 contained in the alumina-series green sheet is less than 0.05 in weight part, the bondability will be worsened. If SiO2 exceeds 10 in weight part, the strength of sintered materials will be worsened. As a result, the strength of the gas sensing element is reduced. The gas sensing element may cause cracks.

In the present invention, the zirconia-series material is defined as a material chiefly containing ZrO2 together with various additives (sintering assistant etc.). The zirconium oxide serves as a solid electrolytic member having oxygen ion conductivity. Binder and solvent are excluded.

The alumina-series material is defined as a material chiefly containing A1203 together with various additives (sintering assistant etc.). binder is excluded.

The alumina-series material of the present invention may include alumina silicate (mullite: SiO2-A1203, etc.) or steatite.

Regarding the manufacturing method of the multilayered gas sensing element of the present invention, it is possible to apply or coat a paste containing SiO2 on each of a zirconia-series green sheet and an alumina-series green sheet. In this case, two green sheets are bonded at their surfaces the paste is applied, and then sintered together.

### BRIEF DESCRIPTION OF THE DRAWINGS

The above and other objects, features and advantages of the present invention will become more apparent from the following detailed description which is to be read in conjunction with the accompanying drawings, in which:

FIG. 1 is a cross-sectional view showing a multilayered gas sensing element in accordance with a preferred embodiment of the present invention;

FIG. 2 is a perspective exploded view showing the multilayered gas sensing element shown in FIG. 1;

FIG. 3A is a view showing a bonding boundary intervening between a zirconia-series solid electrolytic sheet and an alumina-series insulating sheet in accordance with the preferred embodiment of the present invention;

FIG. 3B is an enlarged view showing a region A shown in FIG. 3A;

FIG. 3C is an enlarged view showing a region B shown in FIG. 3A;

FIG. 4 is a view showing undulation of the bonding boundary intervening between the zirconia-series solid electrolytic sheet and the alumina-series insulating sheet in accordance with the preferred embodiment of the present invention;

FIG. 5A is a view showing a test piece used in a tensile test in accordance with the preferred embodiment of the present invention;

FIG. 5B is a view showing the tensile test in accordance with the preferred embodiment of the present invention;

FIG. 6 is a cross-sectional view showing another multilayered gas sensing element in accordance with the present invention;

FIG. 7 is a perspective exploded view showing the multilayered gas sensing element shown in FIG. 6;

FIG. 8 is a cross-sectional view showing another multilayered gas sensing element incorporating no heater in accordance with the present invention;

FIG. 9 is a perspective exploded view showing the multilayered gas sensing element shown in FIG. 8;

FIG. 10 is a cross-sectional view showing another multilayered gas sensing element incorporating no heater in accordance with the present invention; and

FIG. 11 is a perspective exploded view showing the multilayered gas sensing element shown in FIG. 10.

### DESCRIPTION OF THE PREFERRED EMBODIMENTS

Preferred embodiments of the present invention will be explained hereinafter with reference to attached drawings. Identical parts are denoted by the same reference numerals throughout the drawings.

A multilayered gas sensing element of a preferred embodiment will be explained with reference to FIGS. 1 to 5B.

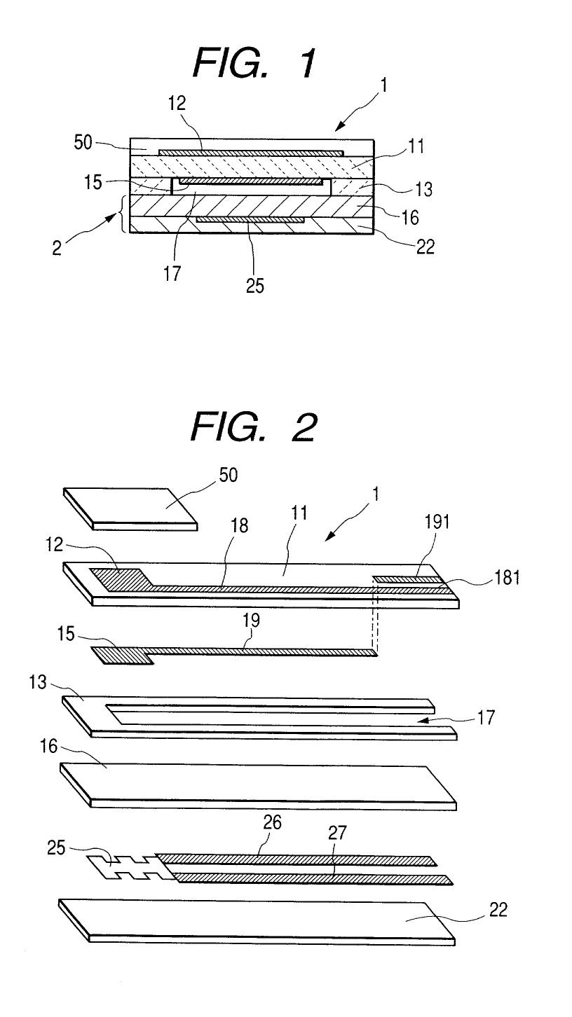

As shown in FIGS. 1 and 2, a multilayered gas sensing element 1 of the preferred embodiment comprises a zirconia-series solid electrolytic sheet 11 and an alumina-series insulating sheet 13.

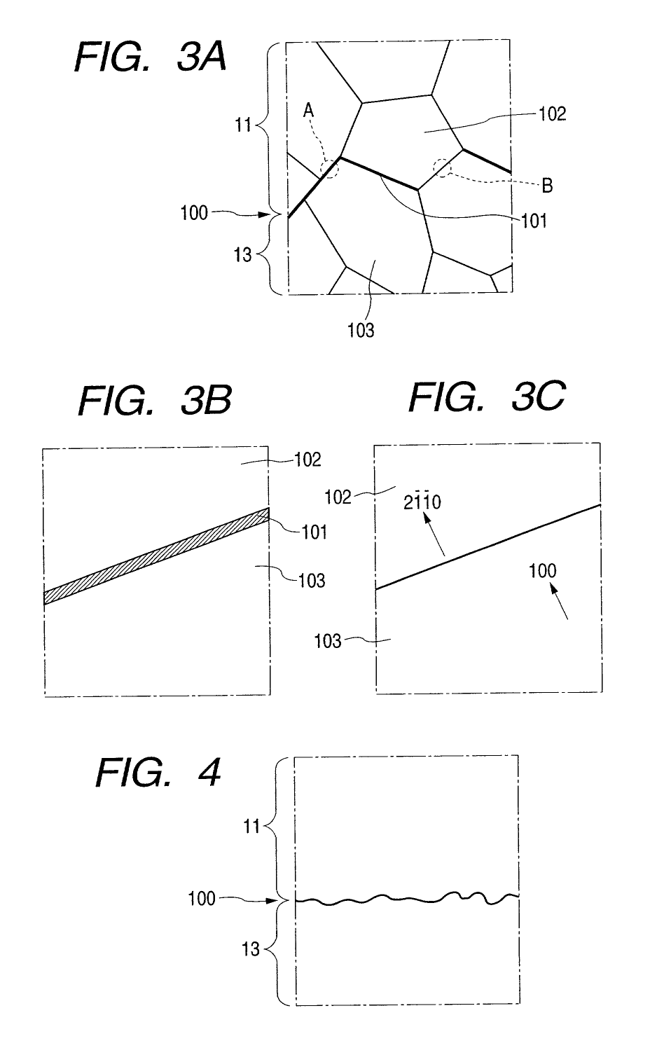

As shown in FIG. 3A, a bonding boundary 100 intervenes between the zirconia-series solid electrolytic sheet 11 and the alumina-series insulating sheet 13. The bonding boundary 100 includes at least partly a crystal phase 101 which contains silicon dioxide (SiO2).

The multilayered gas sensing element 1 of the preferred embodiment is incorporated into a gas sensor which is, for example, installed in an exhaust system of an automotive internal combustion engine. The gas sensor serves as an air-fuel ratio sensor utilized in combustion control of an internal combustion engine.

More specifically, as shown in FIGS. 1 and 2, the multilayered gas sensing element 1 comprises laminated layers of the zirconia-series solid electrolytic sheet (hereinafter, simply referred to as solid electrolytic sheet) 11, the alumina-series insulating sheet (hereinafter, simply referred to as insulating sheet) 13 having a reference gas chamber 17 defined therein, and a heater 2. The heater 2 comprises a heat generating element 25 embedded between a pair of alumina-series insulating sheets 16 and 22. The heat generating element 25 generates heat in response to electric power supplied thereto.

The solid electrolytic sheet 11 has an outside front surface and an inside surface. An outside electrode 12, exposed to a measured gas, is provided on the outside surface of the solid electrolytic sheet 11. An inside electrode 15, exposed to a reference gas, is provided on the inside surface of the solid electrolytic sheet

A protective film 50 is provided on the outside surface of the solid electrolytic sheet 11 so as to cover the outside electrode 12.

Furthermore, the outside electrode 12 is integrally formed with a lead 18 and a terminal 181 for outputting a sensor signal of the multilayered gas sensing element 1. Similarly, the inside electrode 15 is integrally formed with a lead 19. The lead 19 is connected via a pinhole (not shown) to a terminal 191 provided on the outer surface of the solid electrolytic sheet 11.

The insulating sheet 13, disposed beneath or behind the solid electrolytic sheet 11, has a rectangular cutout space defining the reference gas chamber 17 into which a reference gas (e.g., air) is introduced. The heater 2, disposed beneath or behind the insulating sheet 13, comprises the heat generating element 25 and its leads 26 and 27 interposed between the insulating sheets 16 and 22.

FIG. 3A explains a detailed condition of the bonding boundary 100 intervening between the solid electrolytic sheet 11 and the insulating sheet 13 of the multilayered gas sensing element 1.

In the bonding boundary 100, a zirconia-series crystal grain 102 of the solid electrolytic sheet 11 is opposed to an alumina-series crystal grain 103 of the insulating sheet 13. As shown in FIG. 3B, at some part of the bonding boundary 100, a crystal phase 101 containing SiO2 intervenes between the zirconia-series crystal grain 102 and the alumina-series crystal grain 103. Furthermore, as shown in FIG. 3C, at some part of the bonding boundary 100, the zirconia-series crystal grain 102 is directly bonded to the alumina-series crystal grain 103.

Furthermore, as shown in FIG. 4, according to the multilayered gas sensing element 1 of this embodiment, the bonding boundary 100 is entirely undulated. Thus, each of the solid electrolytic sheet 11 and the insulating sheet 13 protrudes partly and retracts partly with respect to the other via said bonding boundary.

Furthermore, as shown in FIG. 3C, a specific face of an alumina crystal lattice in the alumina-series crystal grain 103 is directly connected to a specific face of a zirconia crystal lattice in the zirconia-series crystal grain 102. The Miller index (i.e., crystal index) of the specific face is shown in FIG. 3C.

A manufacturing method of the multilayered gas sensing element 1 of the preferred embodiment will be explained hereinafter.

The basic materials used for manufacturing the multilayered gas sensing element 1 are the zirconia-series material and the alumina-series material. The zirconia-series material contains zirconia (i.e., zirconium oxide: ZrO2 ) grains and yttria (i.e., yttrium oxide: Y203 ) grains. The alumina-series material contains alumina (i.e., aluminum oxide: A1203) grains.

First, a zirconia-series green sheet for the solid electrolytic sheet 11 is fabricated in the following manner.

Each of zirconia (ZrO2) and yttria (Y203) is prepared to have a predetermined grain size.

Next, zirconia (ZrO2) and yttria (Y203) are blended together to form a blended powder consisting of 94.0 mol % zirconia and 6.0 mol % yttria. Then, the obtained blended powder is further blended with additives of silicon dioxide (i.e., SiO2) and alumina (A1203). The ingredient of silicon dioxide (SiO2) is 0.15 in weight part and the ingredient of alumina (A1203) is 2.0 in weight part when the blended powder of zirconia (ZrO2) and yttria (Y203) is 100 in weight part. The mixture of zirconia, yttria, silicon dioxide, and alumina is ground and further mixed in a pot mill for a predetermined time.

Next, the ground mixture thus obtained is kneaded with a mixed solution of ethanol and toluene serving as organic solvent, polyvinyl butyral serving as binder, and di-butyl phthalate serving as plasticizer, thereby obtaining a slurry.

Next, the obtained slurry is configured into a plane sheet body by using a doctor blade method. The fabricated sheet body is 0.2 mm thick. A rectangular sheet body having the dimensions of 5 mm×70 mm is cut out of this sheet body, for the solid electrolytic sheet 11. Then, a pinhole is opened at an adequate portion of the sheet body to connect the lead 19 of inside electrode 15 to be formed on the inside surface of the solid electrolytic sheet 11 to the terminal 191 to be formed on the outside surface of the solid electrolytic sheet 11.

Next, a zirconia containing Pt paste is screen printed on opposite surfaces of the rectangular sheet body in the predetermined pattern to form the outside electrode 12, the inside electrode 15, the leads 18 and 19, and the terminals 181 and 191. Thus, the zirconia-series green sheet for the solid electrolytic sheet 11 is obtained.

Next, an alumina-series green sheet for the insulating sheets 13, 16 and 22 is fabricated in the following manner.

In a hot mil, alumina having a predetermined grain size is kneaded with a mixed solution of ethanol and toluene serving as organic solvent, polyvinyl butyral serving as binder, and di-butyl phthalate serving as plasticizer, thereby obtaining a slurry.

Next, the obtained slurry is configured into a plane sheet body by using a doctor blade method. The fabricated sheet body is 0.4 mm thick. A total of three rectangular sheet bodies, each being 5 mm×70 mm, are cut out of this sheet body. Two of three rectangular sheet bodies are directly used for the insulating sheets 16 and 22. The remaining one of three rectangular sheet bodies, for the insulating sheet 13, is further cut to form the reference gas chamber 17.

Regarding the alumina-series green sheet for the insulating sheet 22, pinholes are appropriately opened at the end thereof to supply electric power to the heat generating element 25. Then, an alumina containing Pt paste is screen printed on an inside surface of the rectangular sheet body for the insulating sheet 22 in the predetermined pattern to form the heat generating element 25, the leads 26 and 27, and terminals (not shown).

Next, an alumina-series green sheet for the protective film 50 is fabricated in the following manner.

In a hot mil, alumina having a predetermined grain size is kneaded with a mixed solution of ethanol and toluene serving as organic solvent, polyvinyl butyral serving as binder, and di-butyl phthalate serving as plasticizer, thereby obtaining a slurry. The grain size of the alumina-series green sheet for the protective film 50 is larger than that of the alumina-series green sheet for the insulating sheets 13, 16 and 22.

Next, the obtained slurry is configured into a plane sheet body by using a doctor blade method. The fabricated sheet body is 0.2 mm thick. A rectangular sheet body, being 5 mm×30 mm, is cut out of this sheet body to form the protective film 50.

The thus fabricated zirconia-series green sheet and the alumina-series green sheets are stacked or laminated in a predetermined order (refer to FIGS. 1 and 2) and integrated as a united multilayered body by the thermo-compression bonding.

Thereafter, the united multilayered body is sintered or baked for one hour at the temperature of 1,500° C. thereby finally obtaining the multilayered gas sensing element 1.

The influence of SiO2 and A1203 contained in the zirconia-series green sheet was tested for the purpose of evaluating the bonding strength at the bonding boundary as well as the oxygen ion conductivity of the zirconia-series solid electrolytic sheet. For the evaluation test, samples No. 1 to No. 32 of the multilayered gas sensing element 1 were manufactured.

In the evaluation test, three items of bondability, bonding strength, and oxygen ion conductivity were evaluated.

Regarding the bondability, each tested element sample manufactured according to the above-described manufacturing processes was cut along a plane perpendicular to the longitudinal direction of the element sample. The bonding boundary between the solid electrolytic sheet 11 and the insulating sheet 13 was observed by a scanning electron microscope (i.e., SEM) which has a magnifying power of 4,000.

In the table 1, evaluation of bondability is indicated by good (∘) or bad (×). When any bonding defective was observed, the bondability was indicated by ×. The test sample having no bonding defective was indicated by ∘.

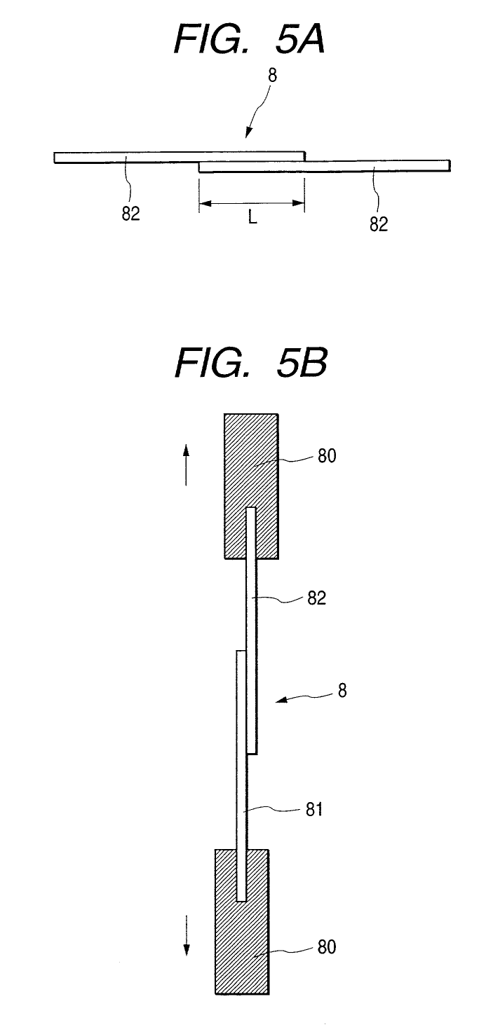

Regarding the bonding strength, a tensile test piece 8 was separately prepared as shown in FIG. 5A. The tensile test piece 8 consists of a solid electrolytic sheet 81 and an insulating sheet 82 bonded at their ends with a predetermined overlap L. The tensile test piece 8 was manufactured by bonding a green sheet for the solid electrolytic sheet 11 (size: 5 mm×70 mm, thickness: 0.2 mm) and a green sheet for the insulating sheet 13 (size: 5 mm×70 mm, thickness: 0.4 mm) in the overlapped manner by the thermo-compression bonding. Then, the tensile test piece 8 was sintered or baked for one hour at the temperature of 1,500° C.

As shown in FIG. 5B, both ends of the tensile test piece 8 were firmly held by fixing portions 80 of a tensile testing machine. Then, the tensile test piece 8 was subjected to a pulling force applied in the arrow direction shown in the drawing.

Result of the tensile test is shown in the table 1.

TABLE 1

| | | | | Breaking | Broken | |
|---|---|---|---|---|---|---|
| | SiO2 | Al2O3 | | weight | state of | Electro- |
| | (in weight | (in weight | Bond- | (in relative | Base | motive |
| No. | part) | part) | ability | value) | material | force |
| 1 | 0.0 | 0.0 | x | 1 | — | 0.9 |
| 2 | 0.1 | 0.0 | ∘ | 1.2 | broken | 0.9 |
| 3 | 0.1 | 0.0 | ∘ | 1.3 | broken | 0.9 |
| 4 | 1.0 | 0.0 | ∘ | 1.3 | broken | 0.9 |
| 5 | 2.0 | 0.0 | ∘ | 1.3 | broken | 0.9 |
| 6 | 3.0 | 0.0 | ∘ | 1.3 | broken | 0.9 |
| 7 | 4.0 | 0.0 | ∘ | 1.3 | broken | 0.9 |
| 8 | 5.0 | 0.0 | ∘ | 1.3 | broken | 0.8 |
| 9 | 0.0 | 0.5 | x | 1.1 | — | 0.9 |
| 10 | 0.0 | 1.0 | x | 1.1 | — | 0.9 |
| 11 | 0.0 | 2.0 | x | 1.1 | — | 0.9 |
| 12 | 0.0 | 3.0 | x | 1.15 | — | 0.9 |
| 13 | 0.0 | 4.0 | x | 1.15 | — | 0.9 |
| 14 | 0.0 | 5.0 | x | 1.15 | — | 0.75 |
| 15 | 0.1 | 0.5 | ∘ | 1.3 | broken | 0.9 |
| 16 | 0.1 | 1.0 | ∘ | 1.3 | broken | 0.9 |
| 17 | 0.1 | 4.0 | ∘ | 1.3 | broken | 0.9 |
| 18 | 0.1 | 5.0 | ∘ | 1.3 | broken | 0.7 |
| 19 | 1.0 | 0.5 | ∘ | 1.3 | broken | 0.9 |
| 20 | 1.0 | 1.0 | ∘ | 1.3 | broken | 0.9 |
| 21 | 1.0 | 2.0 | ∘ | 1.3 | broken | 0.9 |
| 22 | 1.0 | 3.0 | ∘ | 1.3 | broken | 0.9 |
| 23 | 1.0 | 4.0 | ∘ | 1.3 | broken | 0.65 |
| 24 | 2.0 | 0.5 | ∘ | 1.3 | broken | 0.9 |
| 25 | 2.0 | 1.0 | ∘ | 1.3 | broken | 0.9 |
| 26 | 2.0 | 2.0 | ∘ | 1.3 | broken | 0.9 |
| 27 | 2.0 | 3.0 | ∘ | 1.3 | broken | 0.6 |
| 28 | 3.0 | 0.5 | ∘ | 1.3 | broken | 0.9 |
| 29 | 3.0 | 1.0 | ∘ | 1.3 | broken | 0.9 |
| 30 | 3.0 | 2.0 | ∘ | 1.3 | broken | 0.55 |
| 31 | 4.0 | 0.5 | ∘ | 1.3 | broken | 0.85 |
| 32 | 4.0 | 1.0 | ∘ | 1.3 | broken | 0.65 |

The No. 1 test sample contains no additives of SiO2 and A1203. The breaking weight of the No. 1 test sample, designated as a reference value, is expressed by 1. The breaking weight values of other test samples are expressed by relative values with respect to the reference value.

Table 1 shows the broken state of base material in each test sample, in which “----” indicates no abnormality found in the test sample while “broken” indicates breakage of the test sample itself.

Regarding the oxygen ion conductivity, each element sample was exposed to a gas environment of A/F=13 and heated up to the element temperature of 700°C. to measure an electromotive force generated from each element sample. Thus, the oxygen ion conductivity of each element sample was evaluated by the electromotive force generated from this element sample.

Table 1 shows the following result.

(1) Adding SiO2 is effective to improve the bondability as well as to enhance the bonding strength. However, as apparent from the evaluation result of No. 8 test sample, the oxygen ion conductivity is worsened when an added amount of SiO2 is 5 in weight part.

(2) Adding A1203 is effective to enhance the bonding strength but ineffective to improve the bondability. Furthermore, as apparent from the evaluation result of No. 14 test sample, the oxygen ion conductivity is worsened when an added amount of A1203 is 5 in weight part.

(3) Adding both of SiO2 and A1203 is effective to improve the bondability as well as to enhance the bonding strength. However, as apparent from the evaluation result of Nos. 17, 18, 23, 27, 29 to 32 test samples, the oxygen ion conductivity is worsened when a total added amount of SiO2 and A1203 exceeds 4 in weight part.

The multilayered gas sensing element 1 of this embodiment functions in the following manner.

The multilayered gas sensing element 1 is manufactured by using a zirconia-series green sheet containing SiO2. Accordingly, the crystal phase 101 containing SiO2 intervenes between the zirconia-series solid electrolytic sheet 11 and the alumina-series insulating sheet 13.

The crystal phase 101 becomes a liquefied phase during the sintering operation of the multilayered gas sensing element 1. Thus, the material transfer occurs between the zirconia-series solid electrolytic sheet 11 and the alumina-series insulating sheet 13 via the liquefied phase during the sintering operation.

Accordingly, this embodiment provides the multilayered gas sensing element 1 which assures satisfactory bondability between the zirconia-series solid electrolytic sheet 11 and the alumina-series insulating sheet 13.

Furthermore, while SiO2 contributes the bonding strength of the crystal phase 101, the crystal phase 101 containing SiO2 does not worsen the oxygen ion conductivity of the zirconia-series solid electrolytic sheet 11. No blacking or migration is caused even when the crystal phase is subjected to heat generated from the heater 2 embedded in the multilayered gas sensing element 1. Accordingly, the multilayered gas sensing element 1 functions properly.

Thus, this embodiment provides the multilayered gas sensing element having excellent bonding boundary between the zirconia-series solid electrolytic sheet and the alumina-series insulating sheet. Furthermore, this embodiment provides a method for manufacturing this multilayered gas sensing element.

The present invention is not limited to the above-described embodiment, and can be applied to various types of multilayered gas sensing elements.

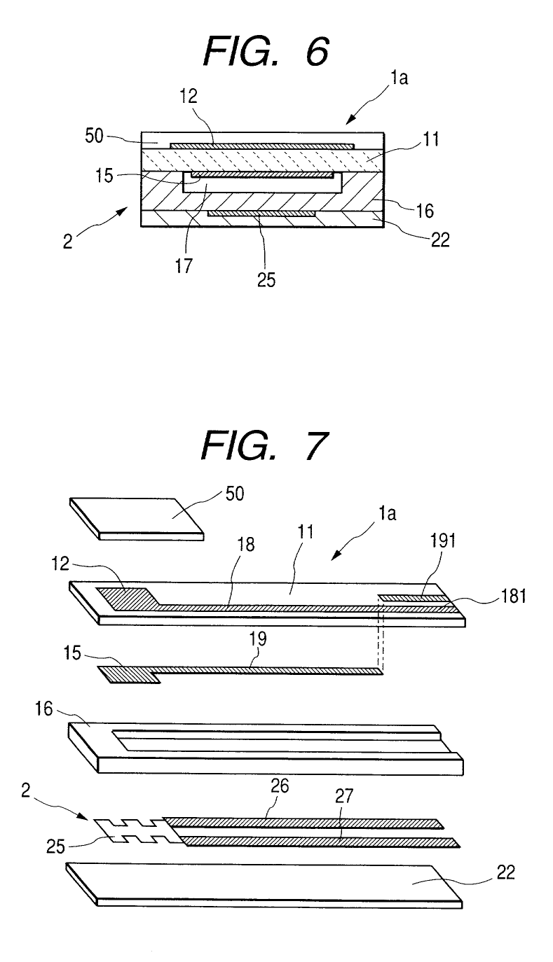

FIGS. 6 to 11 show another multilayered gas sensing elements in accordance with the present invention. As explained with reference to FIGS. 3A-3C and 4, these multilayered gas sensing elements are characterized in that the crystal phase containing SiO2 is included at least partly in the bonding boundary between the zirconia-series solid electrolytic sheet and the alumina-series insulating sheet.

FIGS. 6 and 7 shows a multilayered gas sensing element 1a comprising a zirconia-series solid electrolytic sheet 11, an alumina-series insulating sheet 161 having a reference gas chamber 17 defined therein for introducing a reference gas (e.g., air), and a heater 2. The heater 2 comprises a heat generating element 25 embedded between a pair of alumina-series insulating sheets 16 and 22. The heat generating element 25 generates heat in response to electric power supplied thereto.

The solid electrolytic sheet 11 has an outside surface and an inside surface. An outside electrode 12, exposed to a measured gas, is provided on the outside surface of the solid electrolytic sheet 11. An inside electrode 15, exposed to the reference gas, is provided on the inside surface of the solid electrolytic sheet 11. A protective film 50 is provided on the outside surface of the solid electrolytic sheet 11 so as to cover the outside electrode 12.

Furthermore, the outside electrode 12 is integrally formed with a lead 18 and a terminal 181 for outputting a sensor signal of the multilayered gas sensing element 1a. Similarly, the inside electrode 15 is integrally formed with a lead 19. The lead 19 is connected via a pinhole (not shown) to a terminal 191 provided on the outer surface of the solid electrolytic sheet 11.

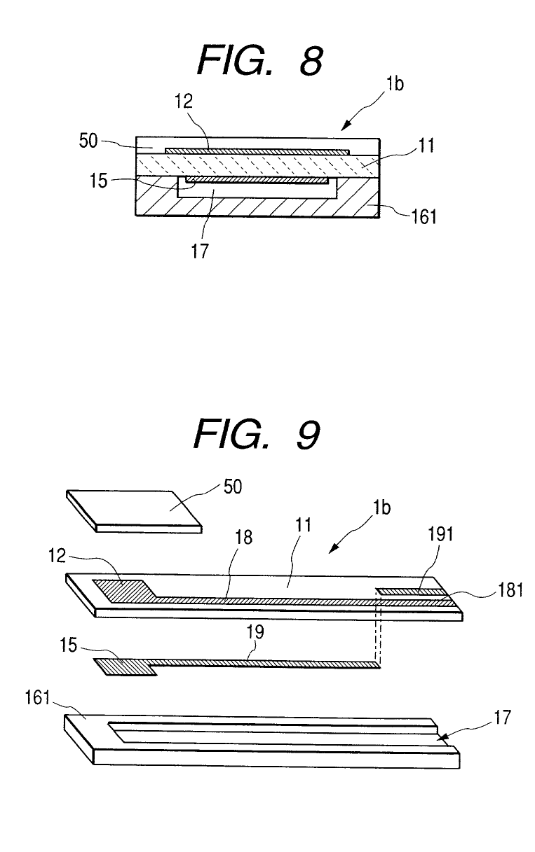

FIGS. 8 and 9 show a multilayered gas sensing element 1b comprising a zirconia-series solid electrolytic sheet 11 and an alumina-series insulating sheet 161 having a reference gas chamber 17 defined therein for introducing a reference gas (e.g., air). The solid electrolytic sheet 11 has an outside surface and an inside surface. An outside electrode 12, exposed to a measured gas, is provided on the outside surface of the solid electrolytic sheet 11. An inside electrode 15, exposed to the reference gas, is provided on the inside surface of the solid electrolytic sheet 11. A protective film 50 is provided on the outside surface of the solid electrolytic sheet 11 so as to cover the outside electrode 12.

Furthermore, the outside electrode 12 is integrally formed with a lead 18 and a terminal 181 for outputting a sensor signal of the multilayered gas sensing element 1a. Similarly, the inside electrode 15 is integrally formed with a lead 19. The lead 19 is connected via a pinhole (not shown) to a terminal 191 provided on the outer surface of the solid electrolytic sheet 11.

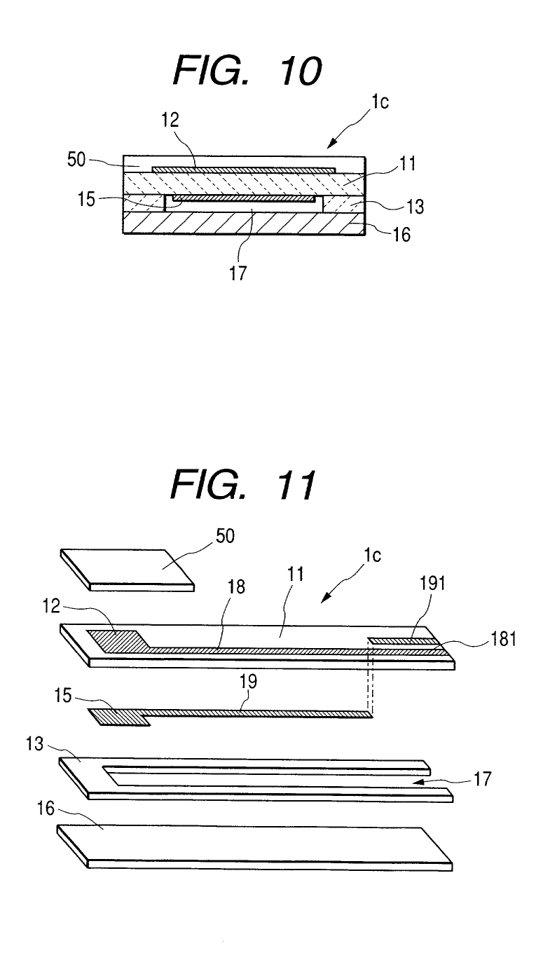

FIGS. 10 and 11 show a multilayered gas sensing element 1c comprising a zirconia-series solid electrolytic sheet 11, an alumina-series insulating sheet 13 having a reference gas chamber 17 defined therein for introducing a reference gas (e.g., air), and an alumina-series insulating sheet 16. The solid electrolytic sheet 11 has an outside surface and an inside surface. An outside electrode 12, exposed to a measured gas, is provided on the outside surface of the solid electrolytic sheet 11. An inside electrode 15, exposed to a reference gas, is provided on the inside surface of the solid electrolytic sheet 11. A protective film 50 is provided on the outside surface of the solid electrolytic sheet 11 so as to cover the outside electrode 12.

Furthermore, the outside electrode 12 is integrally formed with a lead 18 and a terminal 181 for outputting a sensor signal of the multilayered gas sensing element 1a. Similarly, the inside electrode 15 is integrally formed with a lead 19. The lead 19 is connected via a pinhole (not shown) to a terminal 191 provided on the outer surface of the solid electrolytic sheet 11.

As explained above, the present invention provides a multilayered gas sensing element comprising laminated layers comprising a zirconia-series solid electrolytic sheet and an alumina-series insulating sheet, a bonding boundary intervening between the zirconia-series solid electrolytic sheet and the alumina-series insulating sheet, and a crystal phase containing SiO2 and being included at least partly in the bonding boundary.

Preferably, when the crystal phase is 100 wt %, the amount of SiO2 is equal to or larger than 10 wt %.

The crystal phase containing SiO2 intervenes between the zirconia-series solid electrolytic sheet and the alumina-series insulating sheet. The crystal phase causes self-reaction or interacts with other components during the sintering operation of the multilayered gas sensing element. The crystal phase is liquefied. Thus, the material transfer occurs between the zirconia-series solid electrolytic sheet and the alumina-series insulating sheet via the liquefied phase during the Wintering operation.

Accordingly, the present invention provides the multilayered gas sensing element which assures satisfactory bonding between the zirconia-series solid electrolytic sheet and the alumina-series insulating sheet.

Furthermore, while SiO2 contributes the bonding strength of the crystal phase, the crystal phase containing SiO2 does not worsen the oxygen ion conductivity of the zirconia-series solid electrolytic sheet. No blacking or migration is caused even when the crystal phase is subjected to heat generated from the heater embedded in the multilayered gas sensing element. Accordingly, the multilayered gas sensing element functions properly.

Thus, the present invention provides a multilayered gas sensing element having excellent bonding boundary between the zirconia-series solid electrolytic sheet and the alumina-series insulating sheet.

The multilayered gas sensing element of the present invention can be employed in various types of gas concentration sensors, such as an oxygen sensor, an air-fuel ratio sensor, a NOx sensor, a HC sensor, a CO sensor.

According to the multilayered gas sensing element of the present invention, it is preferable that the crystal phase containing silicon dioxide further contains at least one component selected from the group consisting of calcium oxide (CaO), magnesium oxide (MgO), barium oxide (BaO), and strontium oxide (SrO).

The component selected from the group consisting of CaO, MgO, BaO, and SrO interacts with SiO2 so as to promote the liquefaction of the crystal phase during the sintering operation. The material transfer in the bonding boundary advances so smoothly that reliable bonding can be assured between the zirconia-series solid electrolytic sheet and the alumina-series insulating sheet.

According to the multilayered gas sensing element of the present invention, it is preferable that bonding boundary between the zirconia-series solid electrolytic sheet and the alumina-series insulating sheet is undulated.

This arrangement provides anchor effect which ensures reliable bonding between the zirconia-series solid electrolytic sheet and the alumina-series insulating sheet.

According to the multilayered gas sensing element of the present invention, it is preferable that a crystal lattice of the zirconia-series solid electrolytic sheet is connected to a crystal lattice of the alumina-series insulating sheet in the bonding boundary.

This arrangement strengthens the bonding force between the zirconia-series solid electrolytic sheet and the alumina-series insulating sheet.

According to the multilayered gas sensing element of the present invention, it is preferable that a thermal expansion coefficient difference between the zirconia-series solid electrolytic sheet and the alumina-series insulating sheet is equal to or less than 2×10⁻⁶.

This is effective to reduce the stress acting between the zirconia-series solid electrolytic sheet and the alumina-series insulating sheet due to thermal expansion difference, thereby realizing a thermally durable bonding structure. Needless to say, it is most preferable that there is no difference in thermal expansion coefficient between the zirconia-series solid electrolytic sheet and the alumina-series insulating sheet.

According to the multilayered gas sensing element of the present invention, it is preferable that a sintering contraction coefficient difference between the zirconia-series solid electrolytic sheet and the alumina-series insulating sheet is equal to or less than 3%.

With this arrangement, it becomes possible to prevent the multilayered gas sensing element from being damaged during the sintering operation. Needless to say, it is most preferable that there is no difference in sintering contraction coefficient between the zirconia-series solid electrolytic sheet and the alumina-series insulating sheet.

Regarding the manufacturing method, the present invention provides a first method for manufacturing a multilayered gas sensing element comprising the steps of preparing a zirconia-series green sheet containing SiO2 and A1203 for forming a solid electrolytic sheet, preparing an alumina-series green sheet for forming an insulating sheet, bonding the zirconia-series green sheet and the alumina-series green sheet to constitute an unburnt laminated body, and sintering the unburnt laminated body.

According to the first manufacturing method of the present invention, the liquefied phase appears during the sintering operation at a region where a zirconia grain and an alumina grain contact with each other. The liquefied phase chiefly contains SiO2 which has melted into this liquefied phase from the zirconia-series green sheet during the sintering operation of the laminated green sheets.

This is effective to promote the material transfer in the bonding boundary during the sintering operation. The components constituting the liquefied phase can function as binder as they harden themselves in a cooling process succeeding the sintering operation. Thus, the first manufacturing method of the present invention makes it possible to provide reliable and excellent bonding structure for the multilayered gas sensing element.

An A1203 grain contained in the zirconia-series green sheet is well bonded to the alumina(i.e., A1203)-series green sheet. Thus, as shown in FIG. 4, the bonding boundary between the zirconia-series solid electrolytic sheet and the alumina-series insulating sheet is undulated adequately. The undulated bonding boundary possesses the anchor effect which ensures reliable bonding between the zirconia-series solid electrolytic sheet and the alumina-series insulating sheet.

Thus, the multilayered gas sensing element manufactured according to the first manufacturing method has excellent bonding boundary between the zirconia-series solid electrolytic sheet and the alumina-series insulating sheet.

According to the first manufacturing method of the present invention, it is preferable that the zirconia-series green sheet contains SiO2 by 0.05 to 4 in weight part and A1203 by 0.5 to 4 in weight part when zirconia material is 100 in weight part, with a sum of SiO2 and A1203 being not larger than 4 in weight part.

With this composition, it becomes possible to further enhance the bonding strength and improve the bondability.

If SiO2 contained in the zirconia-series green sheet is less than 0.05 in weight part, the bondability will be worsened. If SiO2 exceeds 4 in weight part, the oxygen ion conductivity of the zirconia-series solid electrolytic sheet will be worsened.

Furthermore, if A1203 contained in the zirconia-series green sheet is less than 0.5 in weight part, the bondability will be worsened. If A1203 exceeds 4 in weight part, the oxygen ion conductivity of the zirconia-series solid electrolytic sheet will be worsened.

Furthermore, if the sum of SiO2 and A1203 exceeds 4 in weight part, the oxygen ion conductivity of the zirconia-series solid electrolytic sheet will be worsened.

According to the present invention, it is possible to prepare an alumina-series green sheet containing SiO2 instead of using the zirconia-series green sheet. Similar effects will be obtained.

In this respect, the present invention provides a second method for manufacturing a multilayered gas sensing element, comprising the steps of preparing a zirconia-series green sheet for forming a solid electrolytic sheet, preparing an alumina-series green sheet containing SiO2 for forming an insulating sheet, bonding the zirconia-series green sheet and the alumina-series green sheet to constitute an unburnt laminated body, and sintering the unburnt laminated body.

According to the second manufacturing method of the present invention, the liquefied phase appears during the sintering operation at a region where a zirconia grain and an alumina grain contact with each other. The liquefied phase chiefly contains SiO2 which has melted into this liquefied phase from the alumina-series green sheet during the sintering operation of the laminated green sheets.

This is effective to promote the material transfer in the bonding boundary during the sintering operation. The components constituting the liquefied phase can function as binder as they harden themselves in a cooling process succeeding the sintering operation.

According to the second manufacturing method of the present invention, it is preferable that the alumina-series green sheet contains SiO2 by 0.05 to 10 in weight part when alumina material is 100 in weight part.

With this composition, it becomes possible to further enhance the bonding strength and improve the bondability.

If SiO2 contained in the alumina-series green sheet is less than 0.05 in weight part, the bondability will be worsened. If SiO2 exceeds 10 in weight part, the strength of sintered materials will be worsened. As a result, the strength of the gas sensing element is reduced. The gas sensing element may cause cracks.

Furthermore, according to the present invention, it is possible to use both the zirconia-series green sheet containing SiO2 and the alumina-series green sheet containing SiO2. Similar effects will be obtained.

In this respect, the present invention provides a third method for manufacturing a multilayered gas sensing element, comprising the steps of preparing a zirconia-series green sheet containing SiO2 and A1203 for forming a solid electrolytic sheet, preparing an alumina-series green sheet containing SiO2 for forming an insulating sheet, bonding the zirconia-series green sheet and the alumina-series green sheet to constitute an unburnt laminated body, and sintering the unburnt laminated body.

According to the third manufacturing method of the present invention, the liquefied phase appears during the sintering operation at a region where a zirconia grain and an alumina grain contact with each other. The liquefied phase chiefly contains SiO2 which has melted into this liquefied phase from both the zirconia-series green sheet and the alumina-series green sheet during the sintering operation of the laminated green sheets.

This is effective to promote the material transfer in the bonding boundary during the sintering operation. The components constituting the liquefied phase can function as binder as they harden themselves in a cooling process succeeding the sintering operation.

Thus, the multilayered gas sensing element manufactured according to the third manufacturing method has excellent bonding boundary between the zirconia-series solid electrolytic sheet and the alumina-series insulating sheet.

According to the third manufacturing method of the present invention, it is preferable that the zirconia-series green sheet contains SiO2 by 0.05 to 4 in weight part and A1203 by 0.5 to 4 in weight part when zirconia material is 100 in weight part, with a sum of SiO2 and A1203 being not larger than 4 in weight part.

Furthermore, it is preferable that the alumina-series green sheet contains SiO2 by 0.05 to 10 in weight part when alumina material is 100 in weight part.

With this composition, it becomes possible to further enhance the bonding strength and improve the bondability.

If SiO2 contained in the zirconia-series green sheet is less than 0.05 in weight part, the bondability will be worsened. If SiO2 exceeds 4 in weight part, the oxygen ion conductivity of the zirconia-series solid electrolytic sheet will be worsened.

Furthermore, if A1203 contained in the zirconia-series green sheet is less than 0.5 in weight part, the bondability will be worsened. If A1203 exceeds 4 in weight part, the oxygen ion conductivity of the zirconia-series solid electrolytic sheet will be worsened. Furthermore, if the sum of SiO2 and A1203 exceeds 4 in weight part, the oxygen ion conductivity of the zirconia-series solid electrolytic sheet will be worsened.

If SiO2 contained in the alumina-series green sheet is less than 0.05 in weight part, the bondability will be worsened. If SiO2 exceeds 10 in weight part, the strength of sintered materials will be worsened. As a result, the strength of the gas sensing element is reduced. The gas sensing element may cause cracks.

In the present invention, the zirconia-series material is defined as a material chiefly containing ZrO2 together with various additives (sintering assistant etc.). The zirconium oxide serves as a solid electrolytic member having oxygen ion conductivity. Binder and solvent are excluded.

The alumina-series material is defined as a material chiefly containing A1203 together with various additives (sintering assistant etc.). binder is excluded.

The alumina-series material of the present invention may include alumina silicate (mullite: SiO2-A1203, etc.) or steatite.

Regarding the manufacturing method of the multilayered gas sensing element of the present invention, it is possible to apply or coat a paste containing SiO2 on each or at least either of a zirconia-series green sheet and an alumina-series green sheet. In this case, two green sheets are bonded at their surfaces the paste is applied, and then sintered together.

This invention may be embodied in several forms without departing from the spirit of essential characteristics thereof. The present embodiments as described are therefore intended to be only illustrative and not restrictive, since the scope of the invention is defined by the appended claims rather than by the description preceding them. All changes that fall within the metes and bounds of the claims, or equivalents of such metes and bounds, are therefore intended to be embraced by the claims.

What is claimed is:

1. A multilayered gas sensing element comprising:
laminated layers comprising a zirconia-series solid electrolytic sheet and an alumina-series insulating sheet,
a bonding boundary intervening between said zirconia-series solid electrolytic sheet and said alumina-series insulating sheet, and
said bonding boundary including at least partly a crystal phase containing silicon dioxide.

2. The multilayered gas sensing element in accordance with claim 1, where said crystal phase further contains at least one component selected from the group consisting of calcium oxide, magnesium oxide, barium oxide, and strontium oxide.

3. The multilayered gas sensing element in accordance with claim 1, where said bonding boundary between said zirconia-series solid electrolytic sheet and said alumina-series insulating sheet is undulated.

4. The multilayered gas sensing element in accordance with claim 1, where a crystal lattice of said zirconia-series solid electrolytic sheet is connected to a crystal lattice of said alumina-series insulating sheet in said bonding boundary.

5. The multilayered gas sensing element in accordance with claim 1, where a thermal expansion coefficient difference between said zirconia-series solid electrolytic sheet and said alumina-series insulating sheet is equal to or less than 2×10⁻⁶.

6. The multilayered gas sensing element in accordance with claim 1, where a sintering contraction coefficient difference between said zirconia-series solid electrolytic sheet and said alumina-series insulating sheet is equal to or less than 3%.

7. A method for manufacturing a multilayered gas sensing element, comprising the steps of:
preparing a zirconia-series green sheet containing silicon dioxide and aluminum oxide for forming a solid electrolytic sheet;
preparing an alumina-series green sheet for forming an insulating sheet;
bonding said zirconia-series green sheet and said alumina-series green sheet to constitute an unburnt laminated body; and
sintering said unburnt laminated body.

8. The method for manufacturing a multilayered gas sensing element in accordance with claim 7, wherein said zirconia-series green sheet contains silicon dioxide by 0.05 to 4 in weight part and aluminum oxide by 0.5 to 4 in weight part when zirconia material is 100 in weight part with a sum of silicon dioxide and aluminum oxide being not larger than 4 in weight part.

9. A method for manufacturing a multilayered gas sensing element, comprising the steps of:
preparing a zirconia-series green sheet for forming a solid electrolytic sheet;
preparing an alumina-series green sheet containing silicon dioxide for forming an insulating sheet;
bonding said zirconia-series green sheet and said alumina-series green sheet to constitute an unburnt laminated body; and
sintering said unburnt laminated body.

10. The method for manufacturing a multilayered gas sensing element in accordance with claim 9, wherein said alumina-series green sheet contains silicon dioxide by 0.05 to 10 in weight part when alumina material is 100 in weight part.

11. A method for manufacturing a multilayered gas sensing element, comprising the steps of:
preparing a zirconia-series green sheet containing silicon dioxide and aluminum oxide for forming a solid electrolytic sheet;
preparing an alumina-series green sheet containing silicon dioxide for forming an insulating sheet;
bonding said zirconia-series green sheet and said alumina-series green sheet to constitute an unburnt laminated body; and
sintering said unburnt laminated body.

12. The method for manufacturing a multilayered gas sensing element in accordance with claim 11, wherein
said zirconia-series green sheet contains silicon dioxide by 0.05 to 4 in weight part and aluminum oxide by 0.5 to 4 in weight part when zirconia material is 100 in weight part, with a sum of silicon dioxide and aluminum oxide being not larger than 4 in weight part, and
said alumina-series green sheet contains silicon dioxide by 0.05 to 10 in weight part when alumina material is 100 in weight part.
